(19) United States
(12) Patent Application Publication
(10) Pub. No.: US 2014/0289213 A1
(43) Pub. Date: Sep. 25, 2014

(54) Search Engine With Term Cloud

(71) Applicant: Paul Delano, Westport, CT (US)

(72) Inventor: Paul Delano, Westport, CT (US)

(21) Appl. No.: 14/220,509

(22) Filed: Mar. 20, 2014

Related U.S. Application Data
(60) Provisional application No. 61/804,061, filed on Mar. 21, 2013.

(51) Int. Cl. G06F 17/30

(52) U.S. Cl. CPC G06F 17/30864
USPC 707/706

(57) ABSTRACT

A search system includes a server receiving content from one or more content sources. The server is in electronic communication with a user computer over a network and receives search criteria from the user computer to conduct a search of the content. A cloud generator executing on a computer readable medium generates a term cloud for display on the user computer, the term cloud having terms identified using search results from the search of the content, the terms each having a plurality of cloud actions associated therewith. The cloud generator receives one or more selected cloud actions from the user computer and updates the search results using the one or more selected cloud actions. A list generator executing on the server generates a list of results for display on the user computer using the search results

### FIELD OF THE INVENTION

The present teachings relate generally to techniques for searching information and, more particularly, to the use of term clouds for searching online content.

### BACKGROUND OF THE INVENTION

Users of computational devices such as laptops, smart phones, personal digital assistants and the like have access to very large quantities of data. The vast majority of the data is stored in databases and/or may be accessible via means of communications such as the Internet, or other wired or wireless networks capable of transmitting data. As a result, there is a great amount of available information.

Search systems in the prior art traditionally rely on keywords provided by a user in order to identify relevant information. For example, search engines available on the Internet typically offer plain text search queries with optional search-directives (e.g., such as “and”/“or” with “-” to exclude). While such search systems have made the identification and retrieval of information easier, the retrieved information often includes information that is not relevant to the user, making the search experience sometimes overwhelming.

“Tag clouds” have been used in the past on websites as a visual representation of text data. In the language of visual design, a tag cloud is a kind of “weighted list”, as commonly used on geographic maps to represent the relative size of cities in terms of relative typeface size. Tags are usually single words, and the importance of each tag may be shown with font size or color, which may be useful for quickly perceiving the most prominent terms. One type of tag cloud application includes a tag for the frequency of use of each item. When used as website navigation aids, the terms may be hyperlinked to items associated with the tag.

While “tag clouds” provide some benefits in categorizing and identifying terms, they still lack user interaction to deliver more targeted search results. Therefore, it would be beneficial to have a superior system and method for a search engine with a term cloud.

### SUMMARY OF THE INVENTION

The needs set forth herein as well as further and other needs and advantages are addressed by the present embodiments, which illustrate solutions and advantages described below.

The system of the present embodiment includes, but is not limited to, a server receiving content from one or more content sources, the server in electronic communication with a user computer over a network and receiving search criteria from the user computer to conduct a search of the content. A cloud generator executing on a computer readable medium generates a term cloud for display on the user computer, the term cloud having terms identified using search results from the search of the content, the terms each having a plurality of cloud actions associated therewith. The cloud generator receives one or more selected cloud actions from the user computer and updates the search results using the one or more selected cloud actions. A list generator executing on the server generates a list of results for display on the user computer using the search results.

In another embodiment, the system includes, but is not limited to, a server providing a webpage to a user computer over a network. The webpage has a search interface receiving search criteria from the user computer to conduct a search of content provided by one or more content sources. The webpage also has a cloud interface displaying a term cloud, the term cloud having terms identified using search results from the search of the content, the terms each having a plurality of cloud actions associated therewith. The webpage further has a list of results comprising the search results. The server receives one or more selected cloud actions from the user computer and updates the search results using the selected one or more cloud actions. The plurality of cloud actions includes at least one of: adding weight to a term to increase its importance in the list of results; and selecting a term from the term cloud to require its presence in the list of results.

The method of the present embodiment includes the steps, but is not limited to, receiving, with a server, content from one or more content sources; receiving, with the server, search criteria from a user computer to conduct a search of the content; generating a term cloud for display on the user computer, the term cloud having terms identified using search results from the search of the content, the terms each having a plurality of cloud actions associated therewith; receiving, with the server, one or more selected cloud actions from the user computer, and updating the search results using the selected one or more cloud actions; and generating a list of results for display on the user computer using the search results.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a schematic block diagram of one embodiment of the system according to the present teachings.

FIGS. 2-6 are embodiments of a user interface according to the system of FIG. 1.

FIGS. 7A-7C are action flow charts according to embodiments of the system of FIG. 1.

FIG. 8 is a data flow chart according to one embodiment of the system of FIG. 1.

FIG. 9 is one embodiment of an algorithm for calculating a term cloud according to the present teachings.

FIG. 10 is another embodiment of a data flow chart according to the system of FIG. 1.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In one embodiment according to the present teachings, systems and methods are disclosed for searching data. Search criteria may be provided by a user and used to generate a “term cloud.” The user can then interact with the term cloud (e.g., remove, add, emphasize terms, etc.) to refine the search results. One unique aspect of the present teachings is the combination of display features and the user interaction with them. The combination of the concepts of search engines, “tag clouds”, content aggregation, and content lists is unique.

There is a need to understand and act on large volumes of textual and other data available today using visualization tools. There is further a need to provide this functionality within web pages, mobile and/or touch screen devices, although not limited thereto. The present teachings provide a way to view and manipulate data by presenting a “cloud” that shows a collection of data with more significant data items or terms in a larger size, or with other visual cues such as position or color, although not limited thereto. The user can then interact with that interface to select terms to display or refine the search results. Terms can also be excluded or enhanced. The selected terms can be used to filter the display of content or the term cloud itself. The content displayed can be saved, sent, deleted or operated in other ways, discussed further below.

The present teachings have applicability in any number of different situations and the present teachings are not limited to any particular embodiments disclosed herein. For example, the present teachings may be used for searching corporate file servers, intranets, news, chat rooms, etc.

The present teachings provide a desirable way to see trends in real-time. For example, in one embodiment a search may be performed on message sources (or chat rooms relating to investing, etc.) and real-time streams of data provide insight into current trends of term use, as shown in a term cloud, which may automatically update (discussed below).

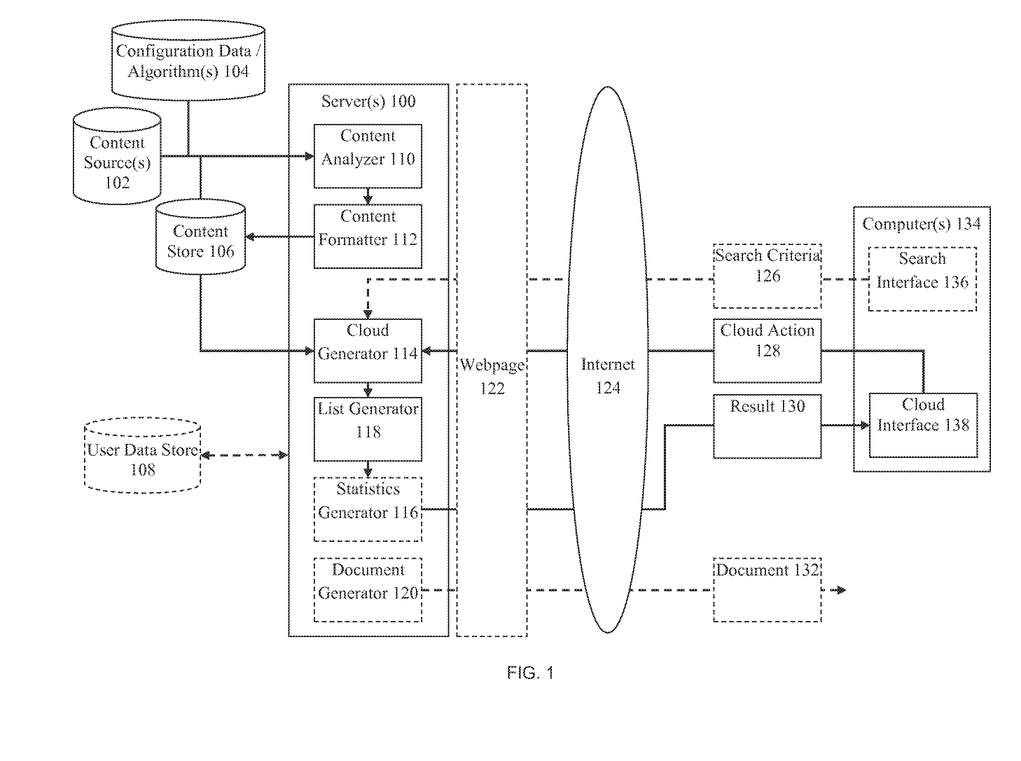

Referring now to FIG. 1, shown is a schematic block diagram of one embodiment of the system according to the present teachings. As shown, one or more user computers 134 may interact with one or more servers 100 in order to conduct searching over a network such as the Internet 124. User computer 134 may include any form of computational device (e.g., laptop, smartphone, desktop, tablet, etc.), and may include both web-enabled and non-web-enabled devices, although not limited thereto.

In one embodiment, the interaction between the user computer(s) 134 and server(s) 100 may utilize a webpage 122, although not limited thereto. In this way, the webpage 122 may provide a user interface for a user to provide search criteria 126 and cloud actions 128, discussed further below. In another embodiment, the user interface may be provided through an application running on the user computer(s) 134, although not limited thereto. What is desirable is to provide an interface for a user of the system on the user computer(s) 134, including a search interface 136 and cloud interface 138, although not limited thereto.

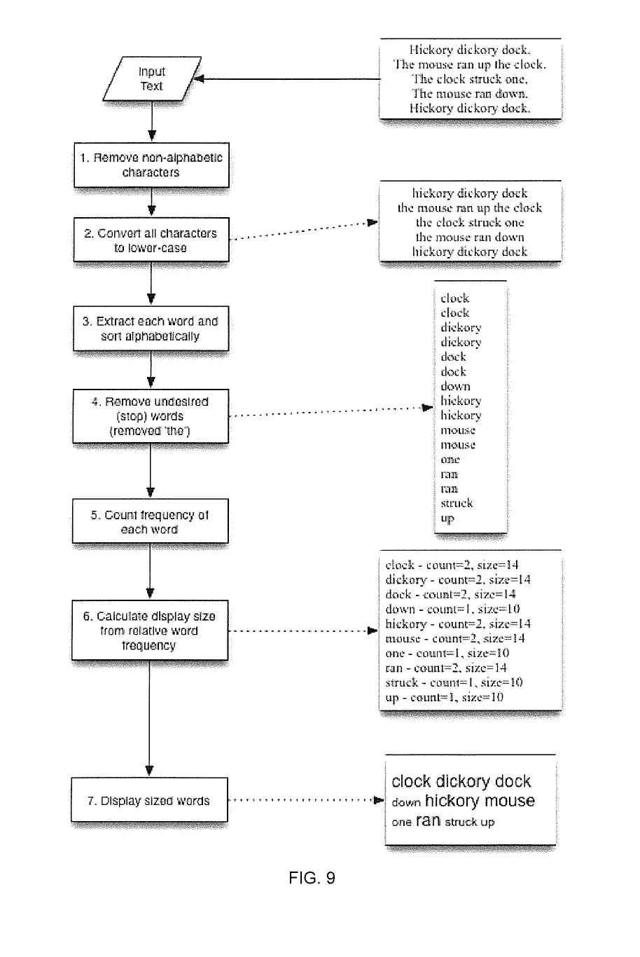

The server may comprise a number of elements, represented by functional blocks in FIG. 1, which may be implemented in hardware, software executing on a computer readable medium, or any combination thereof. For example, a cloud generator 114 may receive search criteria 126 from a search interface 136, and generate a term cloud (may be returned to user computer(s) 134 as result 130). In another embodiment, search criteria may be automatically provided to the cloud generator 114 (e.g., by context, etc.) and not be supplied by a user. An exemplary algorithm for generating a term cloud is discussed below in reference to FIG. 9.

A term cloud may be generated using data stored in content store 106. Storage herein may comprise one or more storages (e.g., databases, data stores, etc.). Information may be provided from any number of content source(s) 102, which may include databases, websites, or any other information available over a network such as the Internet 124, although not limited thereto. A content analyzer 110 may analyze content using configuration data and algorithms 104. Analysis may be performed according to search criteria 126 and/or cloud action 128, although not limited thereto. In another embodiment, content may be analyzed without reference to a search, but instead may be indexed as it becomes available or according to a predetermined schedule, although not limited thereto. What may be desirable is for content from the content source(s) 102 to be analyzed 110 and/or formatted 112 so that it may be accessed by the system.

A list generator 118 may generate a list of search results. This may be based on search criteria 126 and/or cloud action 128, although not limited thereto. What is desirable is to return search results 130 (e.g., which may include term cloud, etc.) to the user.

Results 130 and other system functionality may be based on user profile preferences. To that end, a user may sign up with the system to create a user account and store preferences in user data store 108. For example, the user may prefer to only search content from certain sources, retrieve/share content with predetermined social networks or other recipients, limit results to geographic proximity, have user interface formatting preferences, etc., although not limited thereto. One skilled in the art would appreciate the number of ways user preferences may be used.

In one embodiment, a statistics generator 116 may generate statistics on search results (e.g., results list, term cloud, a combination thereof, etc.). Statistics may be returned to the user as part of the results 130, although not limited thereto.

In one embodiment, the term cloud, search result list, etc., may be generated into a document 132 by document generator 120. This may allow for storing of results 130 for archive purposes, sharing with social networks, etc. Documents may be in any number of formats including pdf for retaining formatting or other formats like xml for data sharing, although not limited thereto.

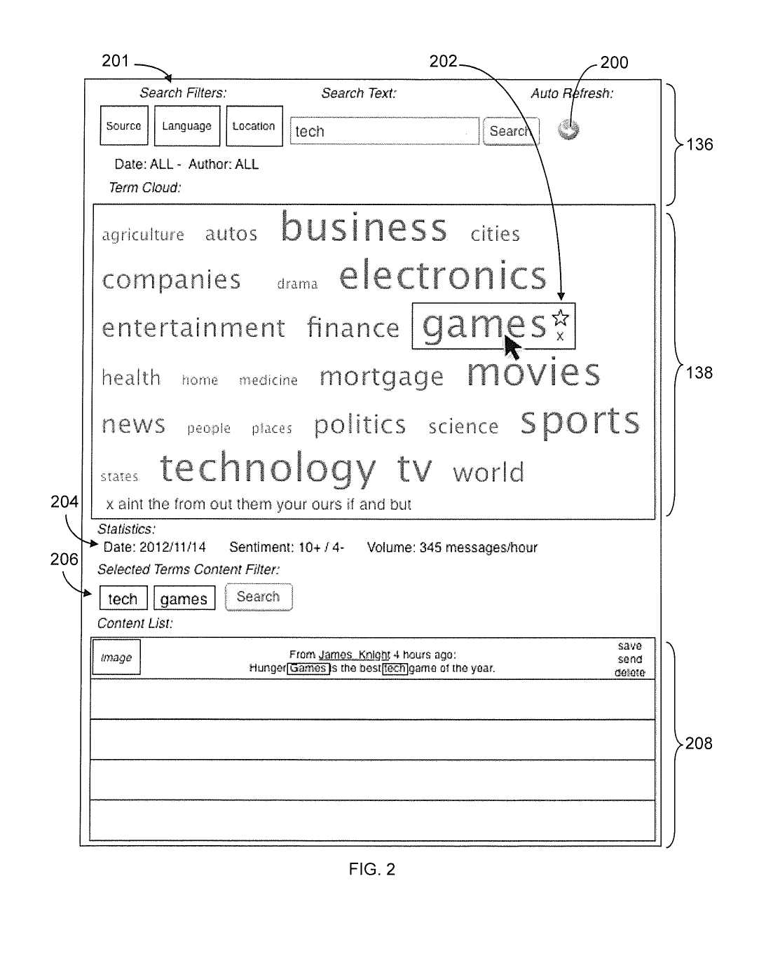

Referring now to FIG. 2, shown is one embodiment of a user interface according to the system of FIG. 1. In one embodiment, the user interface may comprise the result 130 (shown in FIG. 1). As shown, the interface may comprise search interface 136. Here, a user may provide search criteria such as search text, although not limited thereto. A search text field may show the current text terms that are being filtered on. The user can change the text and submit the filter to change the filter text, discussed below, by pressing enter (or when a search button is pressed), although not limited thereto.

A user may also provide any number of search filters 201 (may be part of search interface 136), including filters on content source, language, geo-location, etc., although not limited thereto. Search filters may allow the user to select and refine the content that they are viewing to display what is selected in a concise, visual way. The search filters can include filters for data source, language, geographic location, date and time, author, or other filters. In one example, although not limited thereto, a user may select a message source as a source and may filter language (e.g., English), geographic region (e.g., within geographic proximity, same state, etc.), time (e.g., real-time), etc. The search criteria (e.g., including search filters) may be used to generate a term cloud, discussed further below.

Auto refresh selection 200 may control when and if the term cloud refreshes. It may be desirable to auto refresh the term cloud over time. For example, the term cloud may be set to refresh every 5, 10, 30, 60, 90 seconds, 2 minutes, 5 minutes, 10 minutes, although not limited thereto. The time interval may be displayed or changed with the auto refresh button. The automatic refresh may also be turned off so that the term cloud is only updated when the submit button is pressed, although not limited thereto. A countdown to cloud refresh may also be displayed to the user.

A cloud interface 138 may show the “term cloud,” which may comprise relevant terms found in content identified using search criteria, although not limited thereto. The term cloud may display the most common terms found in the filtered content stream, although not limited thereto. The terms can be words, sequences of words, authors, links, languages or other data attributes that can be aggregated from data streams. More common terms may be shown larger than the less common terms. In addition, display attributes such as text color, highlight color, underscores, font or other presentation features may be used to denote term popularity, historical popularity or other data attributes.

Each term in the cloud may have various cloud actions 202. Hovering a mouse over a cloud term may provide options (e.g., add weight, count in feed, add to search and refresh content list, etc.). For example, when the term is clicked, the content results list may update to show content containing that term. Additional controls may allow the user to mark terms to save for the future (e.g., with a star) or hide from further display (e.g., with an ‘x’), although not limited thereto. Adding weight to a term may increase its importance to the search results, while removing a term from the cloud may remove its importance in the search results. Modifications from multiple users can be aggregated to improve results.

When a term cloud is refreshed, it may be desirable to maintain visual context for the user. To this end, when term sizes are updated, although not limited thereto, a transitional animation may be used. This transitional animation may be accomplished in N steps. First, the system may subtract the end size from the beginning size for each word and divide by N to get the word size differential for each word, which may be positive or negative. For each animation iteration, the differential may be added to the current word size to get the iteration word size used for display. Since there may be different words in the beginning and end of the transition, only the highest weighted words may be displayed in each animation iteration to get a preferred term cloud size. This animation technique may also be adapted to transition other display attributes such as text color, highlight color or font styles, although not limited thereto.

If the term cloud is set to auto refresh, although not limited thereto, the system may speak cloud words as they are added. More popular terms may be spoken louder, although not limited thereto.

Statistics 204 may be provided based on the content selected and summarized in the term cloud, although not limited thereto. Statistics may include the start and end dates of the content stream, sources, sentiment (e.g., positivity and/or negativity), volume of messages, etc., although not limited thereto. These could be represented as numbers, tables, graphs, term clouds or by other means. A sentiment bar may count positive and negative sentiment for each piece of content identified. In one embodiment, sentiment may include counting the number of positive indicating words and subtracting number of negative indicating words in message to get a sentiment score per message. In one embodiment, statistics 204 may include calculating the number of messages found in the timeframe displayed.

One skilled in the art would appreciate that, in one embodiment, to determine the sentiment software may identify the parts of speech that indicate emotion, such as adjective-noun combinations, although not limited thereto. Once these phrases are identified, tone sentiment may be scored by determining how frequently a given phrase occurs near a set of good words (e.g. “good”, “excellent”, etc.) and a set of bad words (e.g. “bad”, “terrible”, etc.).

Similar to the search text filter, a selected terms content filter 206 may display the terms used to filter the content results list. By default, the selected terms content filter 206 may contain the value(s) from the search text. Terms may be added by selecting them from the term cloud to further restrict the filtering. Terms can also be removed from the selected terms content filter 206 to expand the search space. A search button may reset the search text in the search interface 136 with the current selected terms content filter 206.

A content result list 208 may display the selected data and allow the user to interact with it. Content can be displayed as a combination of images, text, hyperlinks or other data. The terms in the content can be highlighted with color, size or other attributes to emphasize them, although not limited thereto. The content displayed can be saved (e.g., locally or to user profile, etc.), sent to others or published via various platforms such as blogs or social media platforms, although not limited thereto. This may be done by generating a document 132 (shown in FIG. 1).

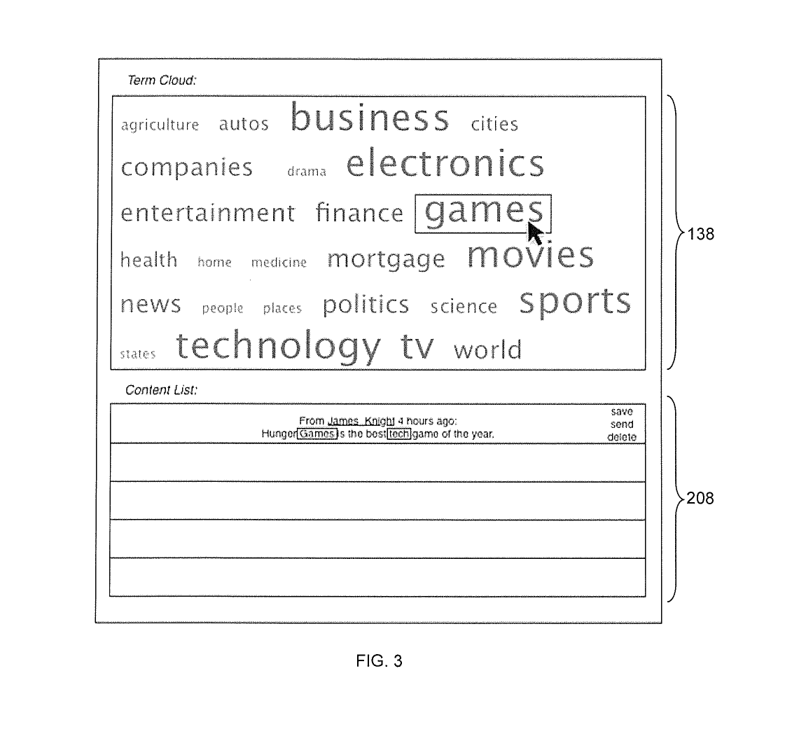

Referring now to FIG. 3, shown is another embodiment of a user interface according to the system of FIG. 1. This may be a more simple implementation that that shown in FIG. 2, and may comprise cloud interface 138 and content result list 208. This implementation can be used to fit the interface on to smaller screens or embedded within other applications or web pages. In the cases where filters are not displayed, the filter values may be set to fixed values or the filters can be overlaid the cloud interface 138 and/or content result list 208, although not limited thereto.

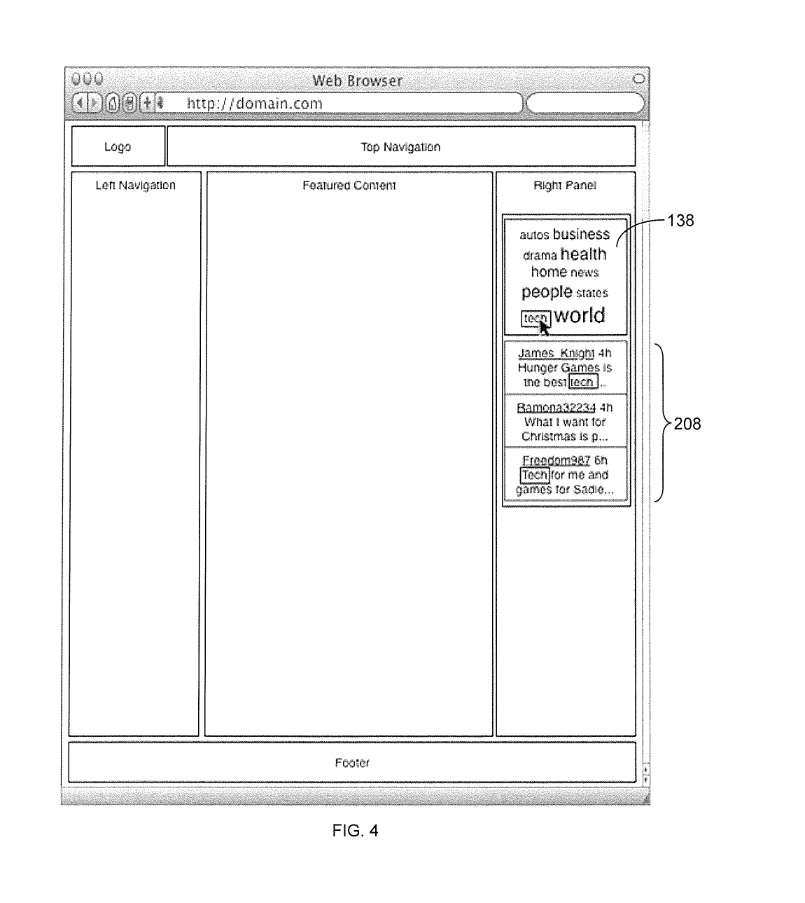

Referring now to FIG. 4, shown is yet another embodiment of a user interface according to the system of FIG. 1. Variations of the interface may be embedded into web pages or other applications. The interactivity of the cloud interface 138 and/or content result list 208 may be fully functional within a web page or application, although not limited thereto. Additionally, it could be configured to redisplay in a new window with additional interface features (e.g., search criteria, etc.).

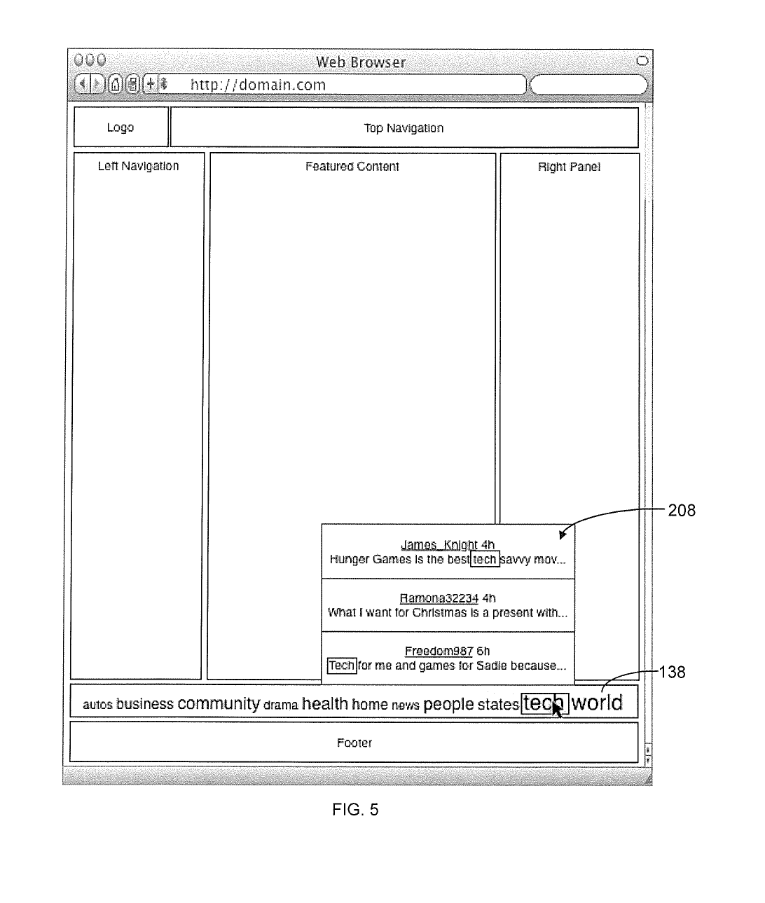

Referring now to FIG. 5, shown is still another embodiment of a user interface according to the system of FIG. 1. Variations of the interface may include formatting the cloud interface 138 as a strip with the content result list 208 in a dedicated panel or displayed over other content when terms are selected, although not limited thereto. The cloud interface 138 may animate as described previously and/or animate as a ticker where the words scroll left or right, although not limited thereto.

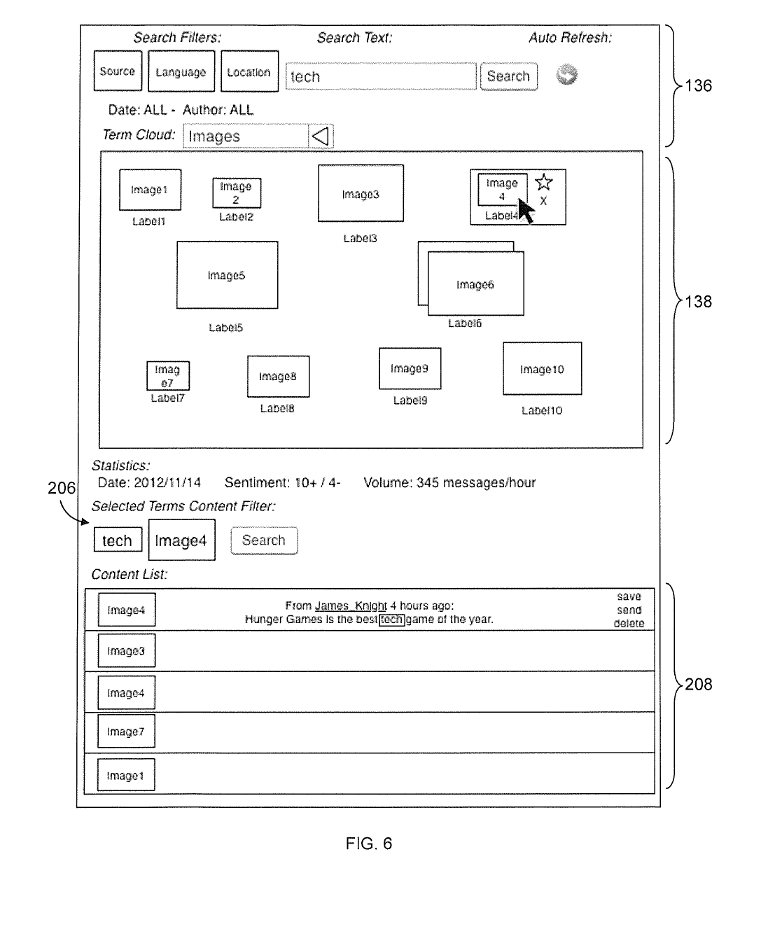

Referring now to FIG. 6, shown is still another embodiment of a user interface according to the system of FIG. 1. This implementation shows how more complex or non-textual data may be presented. As shown, the search interface 136 may be used to filter the data or meta data of the content. In the cloud interface 138, the terms may be presented as images, text, video, or combinations of each. The size and other display properties of each item may denote the popularity or other attributes of each term. The selected terms content filter 206 may also display terms as combinations of images, text and video, although not limited thereto. The content result list 208 may display the content as combinations of images, text and video, although not limited thereto, with the capability to save, share, hide or manipulate the content as appropriate.

Additional filters may include document type (e.g., images, etc.). This may provide associated images in the content result list 208. Filtering may also be based on image caption, title, comments, etc. It is to be appreciated that different document types have different attributes (and meta data) that may be used for searching (and filtering) purposes.

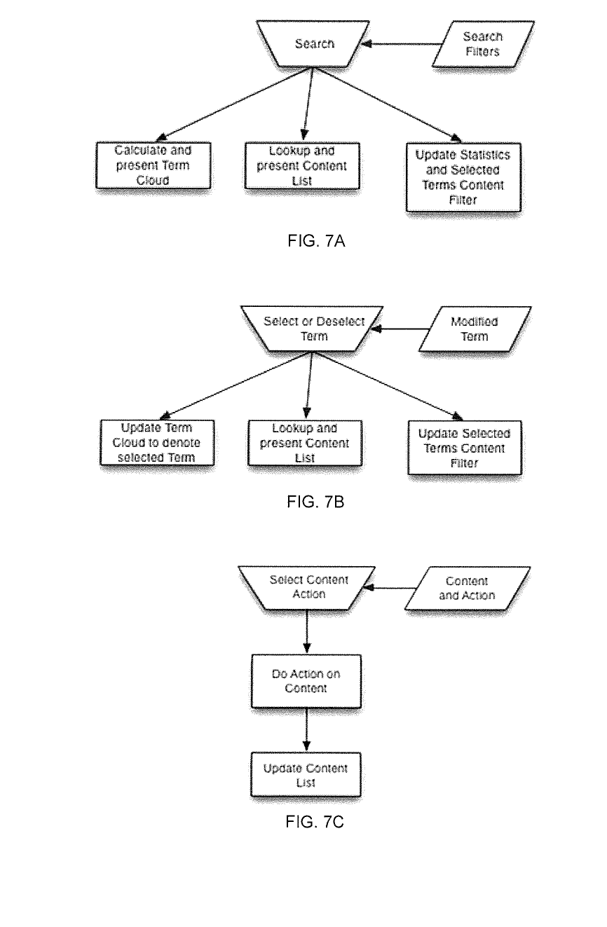

Referring now to FIGS. 7A-7C, shown are action flow charts according to embodiments of the system of FIG. 1. Three operations are shown, namely, searching (FIG. 7A), selecting or deselecting a term (FIG. 7B), and selecting content action (FIG. 7C).

According to FIG. 7A, when a user searches most of the interface may be updated with the search results. Given search criteria, the term cloud may be calculated and presented, and a content result list updated with the selected content. Additionally, statistics and selected terms content filters may be updated.

According to FIG. 7B, when a user selects or deselects a term it may modify a selected terms content filter. The modified term may be added or removed and highlighted or un-highlighted in the term cloud as appropriate. Additionally, a content result list may be updated to use the new selected terms content filter.

According to FIG. 7C, various actions such as saving, sending or deleting can be done to content items. When an action is selected, the action may be performed on the content and a content result list may be updated as appropriate.

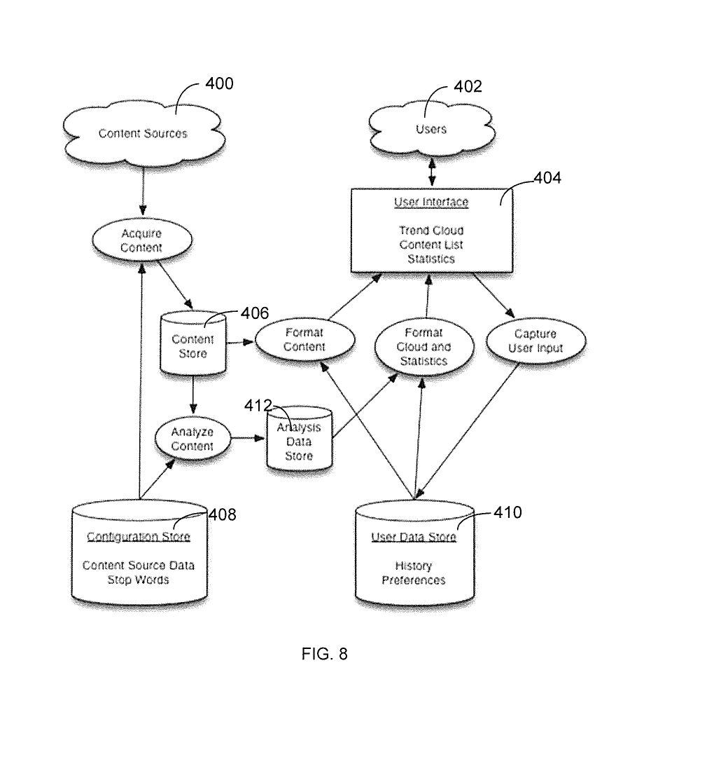

Referring now to FIG. 8, shown is a data flow chart according to one embodiment of the system of FIG. 1. Content sources 400 may include external sources of data. Data is typically text, but can be other forms such as images or video, although not limited thereto. Users 402 may include one or operators of the system. Users 402 typically consume content and generate input as they use the user interface 404, which presents information to the users 402, including term cloud trends, content lists and statistics. User input may be captured to update the user interface 404.

A content store 406 may provide structured storage of content. A configuration store 408 may provide structured storage of configuration data, such as content source configuration data and lists of undesired “Stop Words” (discussed below) and other data, although not limited thereto. A user data store 410 may provide structured storage of user data, such as user interaction history and user preferences, although not limited thereto. An analysis data store 412 may provide structured storage of analytic data.

Content may be acquired from content sources 400, formatted appropriately, and saved in the content store 406. This content may be analyzed with configuration data and analytic information created such as frequency and sentiment to create term clouds and statistics. Analysis information may be saved to the analysis data store 412 and the user interface 404.

The content may then be formatted for presentation to users 402. The term cloud and statistics may be formatted using the analytic information. User input may be captured from the user interface and stored in the user data store 410.

Referring now to FIG. 9, shown is one embodiment of an algorithm for calculating a term cloud according to the present teachings. Shown is a simple representation of how a term cloud can be generated from English text. It includes a flow chart of the processing flow and examples of the data at intermediate steps. The algorithm can be modified to calculate term clouds for other forms of data by counting frequencies of other sorts of terms besides English words, although not limited thereto.

Unstructured text may initially be input. In this example, the text is a popular nursery rhyme. In practice, the text can be combined from many sources and be much larger in volume. According to step 1, non-alphabetic characters may be removed. This may handle characters such as underscore ‘_’, single quote ‘'’, or other characters, each of which may be handled differently according to system preferences.

In step 2, characters may be converted to lower-case. This step may not be necessary or preferable in some embodiments.

In step 3, words may be extracted and sorted alphabetically. This does not necessarily have to be done, but makes the example easier to understand.

In step 4, undesired words (e.g., “stop words”) may be removed. Often connector words such as ‘the’, ‘and’, ‘or’, etc., are removed. For some cases large dictionaries of words may be removed according to predetermined preferences. In this example, the word ‘the’ is removed.

In step 5, the frequency of each word may be counted.

In step 6, the display size may be calculated from relative word frequency. In this example, words with a count of 2 have a size of 14 and those with a count of 1 have a size of 10, although not limited thereto.

In step 7, sized words may be displayed. In this case, the words are shown in alphabetical order in 3 rows, although not limited thereto.

This example is exemplary in nature and not limiting. It may be preferable to calculate the term cloud using any number of different inputs. For example, it may be preferable to calculate the term cloud based on how often an image is clicked, referenced, etc. One skilled in the art would appreciate the various ways a term cloud may be calculated according to the present teachings.

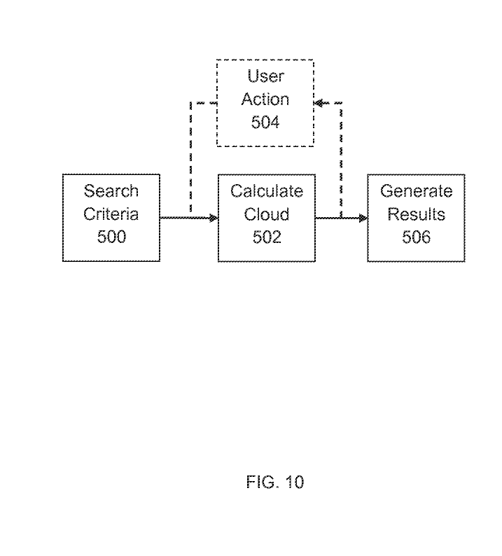

Referring now to FIG. 10, shown is another embodiment of a data flow chart according to the system of FIG. 1. As shown, search criteria 500 may be used to calculate a term cloud 502. User action 504 may modify the term cloud 502 in order to generate desirable results 506.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A search system, comprising:
a server receiving content from one or more content sources, the server in electronic communication with a user computer over a network and receiving search criteria from the user computer to conduct a search of the content;
a cloud generator executing on a computer readable medium and generating a term cloud for display on the user computer, the term cloud having terms identified using search results from the search of the content, the terms each having a plurality of cloud actions associated therewith, the cloud generator receiving one or more selected cloud actions from the user computer and updating the search results using the one or more selected cloud actions; and
a list generator executing on the server and generating a list of results for display on the user computer using the search results.

2. The system of claim 1, further comprising a document generator executing on the server and generating a document using the term cloud and the list of results, the document generator sending the document to one or more recipients.

3. The system of claim 2, wherein the one or more recipients comprises a social networking website.

4. The system of claim 1, further comprising a webpage provided by the server, the webpage having a user interface to receive the search criteria and the one or more selected cloud actions.

5. The system of claim 1, further comprising a statistics generator executing on the server and generating statistics using the list of results, the statistics displayed in proximity to the list of results.

6. The system of claim 5, wherein the statistics comprise sentiment.

7. The system of claim 1, wherein the plurality of cloud actions includes adding weight to a term to increase its importance in the list of results.

8. The system of claim 1, wherein the plurality of cloud actions includes selecting a term from the term cloud to require its presence in the list of results.

9. The system of claim 1, wherein the terms of the term cloud comprise at least one image or video.

10. The system of claim 1, wherein the term cloud is automatically refreshed at predetermined intervals.

11. The system of claim 10, wherein a countdown until a next refresh is displayed.

12. The system of claim 1, wherein the cloud generator further comprises a transitional animator for refreshing the term cloud.

13. The system of claim 1, wherein the server comprises a plurality of computers.

14. The system of claim 1, wherein the one or more content sources comprises third-party websites.

15. The system of claim 1, wherein the cloud generator comprises one or more software components executing on the server.

16. The system of claim 1, wherein the sizes of terms in the term cloud are based on the relative frequency of the terms in the search results.

17. A method for searching content, comprising the steps of:
receiving, with a server, content from one or more content sources;
receiving, with the server, search criteria from a user computer to conduct a search of the content;
generating a term cloud for display on the user computer, the term cloud having terms identified using search results from the search of the content, the terms each having a plurality of cloud actions associated therewith;
receiving, with the server, one or more selected cloud actions from the user computer, and updating the search results using the selected one or more cloud actions; and
generating a list of results for display on the user computer using the search results.

18. The method of claim 17, wherein the term cloud and list of results are automatically refreshed to provide real-time monitoring of the content.

19. The method of claim 17, wherein the content comprises a corporate intranet.

20. A search system, comprising:
a server providing a webpage to a user computer over a network, the webpage having:
a search interface receiving search criteria from the user computer to conduct a search of content provided by one or more content sources;
a cloud interface displaying a term cloud having terms identified using search results from the search of the content, the terms each having a plurality of cloud actions associated therewith; and
a list of results comprising the search results;
wherein the server receives one or more selected cloud actions from the user computer and updates the search results using the selected one or more cloud actions; and
the plurality of cloud actions includes at least one of: adding weight to a term to increase its importance in the list of results; and selecting a term from the term cloud to require its presence in the list of results.

21. The system of claim 20, further comprising a document generator executing on the server and generating a document using the term cloud and the list of results, the document generator sending the document to one or more recipients.
